(19) United States
(12) Patent Application Publication
(10) Pub. No.: US 2020/0008595 A1
(43) Pub. Date: Jan. 9, 2020

(54) FILLING ELEMENT FOR FABRIC PRODUCTS

(71) Applicant: AURLEO HOLDINGS PTY LTD., New South Wales (AU)

(72) Inventor: Julian BRANCACCIO, NEW SOUTH WALES (AU)

(21) Appl. No.: 16/506,192

(22) Filed: Jul. 9, 2019

(30) Foreign Application Priority Data
Jul. 9, 2018 (AU) 2018902487

(51) Int. Cl. A47G 9/10; B68G 7/06

(52) U.S. Cl. CPC A47G 9/10; B68G 2001/005; A47G 2009/1018; B68G 7/06

(57) ABSTRACT

A filling element (10) for filling fabric products comprising a longitudinally extending body portion (12) fabricated from a memory foam, wherein the cross-sectional shape of the filling element (10) is generally in the form of a regular hexagon. However, other cross-sectional profiles for the filling element (10) may be utilised such as stars, squares, rectangles, crosses, triangles, other polyhedrons (regular or irregular), squiggles or waves.

### TECHNICAL FIELD

The present disclosure relates to a filling element for filling fabric products. In particular, the present invention relates to a filling element for use with pillows, cushions and duvets. However, it will be appreciated that the filling element may be used in other applications.

### BACKGROUND OF THE INVENTION

Pillows, cushions and duvets are provided having an outer case or slip and an internal filling material. The fill material serves several purposes. Firstly it provides a desired degree of padding. This is especially important with pillows and cushions, as the padding provides support for a user's head/neck.

Secondly, the fill material is used to achieve desired thermal properties such as the retention of warmth and air breathability.

Pillow fill material has traditionally been made from goose down and more recently down replacements (normally polyester fibres). In more recent times, other materials have become available such as shredded memory foam. Each of these fill materials suffers from inherent drawbacks.

Down may provide favourable thermal properties, but the firmness and support characteristics are often less than desirable for pillows and cushions, as the down tends to compress significantly when loaded. In addition, there is a tendency for down to flatten over time. Furthermore, down filling can be a cause of allergies in some people.

Single piece memory foam pillows are increasingly common, but the lack of adjustability dictates that a pillow which is suitable for one given sleeping position may not be suitable for other positions. It is generally understood that Single piece memory foam pillows are only really of benefit to side and back sleepers.

As such, many people find single piece memory foam pillows to be undesirable. In addition, solid memory foam pillows are known to be excessively warm during use, and provide substandard heat dissipation properties.

A more recent trend involves the use of shredded memory foam as a filling material. However, the shredded foam can be quite inconsistent, as the size of the fill material may vary significantly in a batch, and depends largely on the shredding process. Furthermore, some parts of the fill will contain skin/crusts from the foam block which may be stiffer than portions of the foam obtained from the centre of the block. Another issue concerns very small pieces of cut foam which may readily escape from the pillow casing.

One type of fill material which has been used with pillows is fabricated from cylindrical tubes of polymer, generally in the form of a memory foam. The tubes are advantageous, as they permit a user to customise the fill volume by adding or removing the fill volume from within the pillow or cushion.

However, whilst the abovementioned polymer tubes result in desirable characteristics for pillow/cushion fill adjustability, the manufacturing process is wasteful on account of the fabrication process. This is because the cutting process required to form circular tubes cannot be achieved without generating some unused foam between each of the tubes. Accordingly, a large amount of the foam from the original foam sheet or block is unusable and ultimately wasted. Mathematically, the percentage of wasted foam is over 21%. This results in wasted revenue for the manufacturer. Furthermore, the wasted material is undesirable from an environmental perspective.

### OBJECT OF THE INVENTION

It is an object of the present invention to substantially overcome or at least ameliorate one or more of the above disadvantages, or to provide a useful alternative.

### SUMMARY OF THE INVENTION

In a first aspect, the present invention provides a filling element for filling fabric products comprising:

a longitudinally extending body portion fabricated from a polyurethane foam, wherein the cross-sectional shape of the filling element is generally in the form of a regular hexagon.

The flexible polyurethane foam is preferably under-indexed i.e. viscoelastic “memory foam”.

The filling elements are preferably between about 100 mm and 120 mm in length.

Each filling element is preferably about 10 mm in width.

The present invention provides a pillow or cushion having a casing fabricated from a cellulose fibre fabric, wherein the pillow or cushion is filled with filling elements as described above.

The pillow or cushion further preferably comprises an opening providing access to an internal receptacle.

The filling elements are preferably arranged in the casing with a longitudinal axis of a majority of the filling elements being generally parallel, or at least extending predominantly in a similar direction.

The filling elements are preferably arranged with the longitudinal axis generally following a longitudinal axis of the casing.

The present invention provides a die for fabricating the filling elements as described above, wherein the die has a honeycomb like appearance defined by a plurality of hexagonal die units, each die unit having six edges in the form of blades defining the perimeter of a hexagon.

### BRIEF DESCRIPTION OF THE DRAWINGS

A preferred embodiment of the invention will now be described by way of specific example with reference to the accompanying drawings, in which:

FIG. 1 is a schematic perspective view of a filling element according to the invention;

FIG. 2 is a schematic view of a pillow fabricated using the filling element of FIG. 1;

FIG. 3 is a top view of a die for cutting the filling elements of FIG. 1; and

FIG. 4 is a perspective view depicting a portion of the die of FIG. 3.

### DETAILED DESCRIPTION OF THE PREFERRED EMBODIMENTS

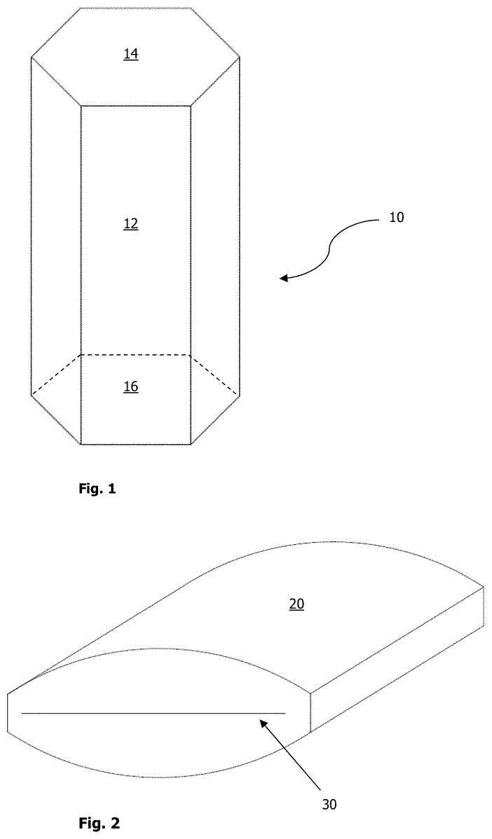

There is disclosed herein a filling element 10 for filling fabric products, and a method of fabricating the filling elements 10 in bulk quantities. In a preferred embodiment, the filling elements 10 each have a body 12 having a cross-sectional area in the form of a regular hexagon, as depicted in FIG. 1. Each of the opposing ends of the filling elements 10 is defined by a planar, regular hexagonal surface 14, 16.

In other embodiments not depicted in the drawings, the filling elements 10 may be provided in other cross sectional profiles, such as (but not limited to) triangles, squares, rectangles, other polyhedrons (regular or irregular). Furthermore, the filling elements 10 may be produced in other shapes such as squiggles, waves, crosses or stars. In one embodiment, the filling elements 10 may have a hollow core such that a longitudinally extending air cavity is located inside each filling element 10. This may provide improved thermal conductivity properties for improved heat dissipation. In the event that the filling element 10 is fabricated with a hollow core, the removed core may act as a further filling element 10. For example, the filling element may be hexagonal in external profile with an internal void having a square, circle or hexagonal cross-sectional profile, which defines a second filling element 10 of smaller external cross-sectional area.

The length of each filling element 10 is preferably between about 100 mm and 120 mm. However, it will be appreciated that the filling elements 10 may be provided in shorter or longer sizes. Furthermore, the width of each filling element 10 is preferably between about 5 mm and 20 mm, and most preferably around 10 mm.

The filling element 10 is fabricated from a polyurethane memory foam. The polyurethane memory foam preferably has a density range of 30 kg/m³-120 kg/m³. Furthermore, the polyurethane memory foam preferably has an indentation load deflection (ILD), which is a measure of firmness, in the range of 5-45 lbs.

In one embodiment, the polyurethane memory foam includes graphene embedded in the foam. The inclusion of graphene provides improved thermal conductivity to enable the filling elements 10 to remove unwanted heat, and keep the pillow 20 or other fabric product cool. It will be appreciated that other materials may be embedded in the foam, or applied as a coating.

The filling elements 10 can be used in a diverse range of applications including but not limited to pillows, cushions, mattress tops, duvets, upholstery, padding, car seats, toys, residential and commercial furniture etc. In fact, the filling 10 elements may be used is any application where padding, filling or various thermal properties are desired.

A pillow or cushion 20 is fabricated using the filling elements 10. The pillow or cushion 20 has an outer cover which is fabricated from a fabric including cellulose fibres, providing desirable breathability properties. In a preferred embodiment, the fabric is a woven cellulose fibre fabric having an optimal thread count range of (300 to 1000). Other fabrics may alternatively be used for the pillow or cushion 20 such as knitted and non-woven fabrics with or without technology coatings or fibre technology that provide desirable physical properties, such as cooling.

The filling elements 10 are arranged in the pillow 20 with the longitudinal axis X of the majority of the filling elements 10 being generally parallel, or at least extending predominantly in a similar direction. The filling elements 10 are also arranged with the longitudinal axis X generally following a longitudinal axis of the pillow 20. As depicted in FIG. 2, the pillow has an opening 30 which enables a user to access the internal receptacle within the pillow 20 to add or remove further filling elements 10 to customise the fill volume of the pillow. The opening 30 is sealed with a suitable fabric fastening means such as a zipper or alternatively a hook and loop fastening system. The casing of the pillow 20 is fabricated from a cellulose based material.

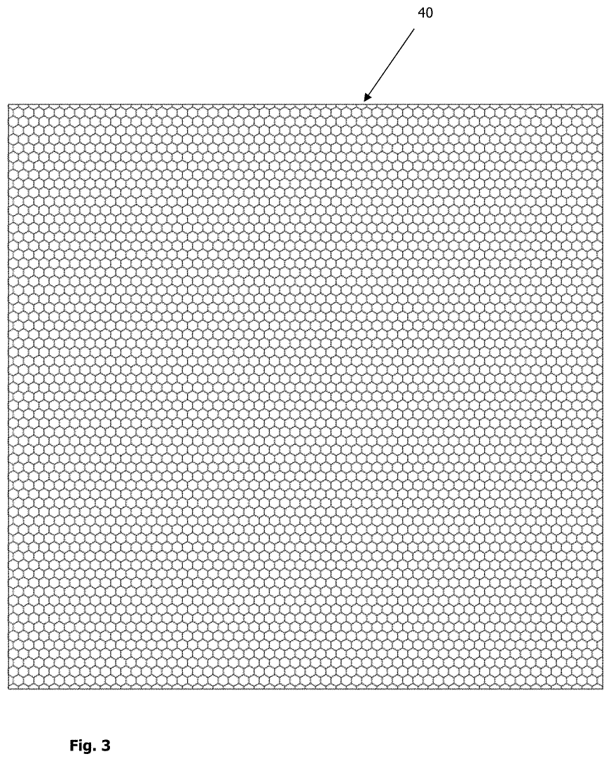

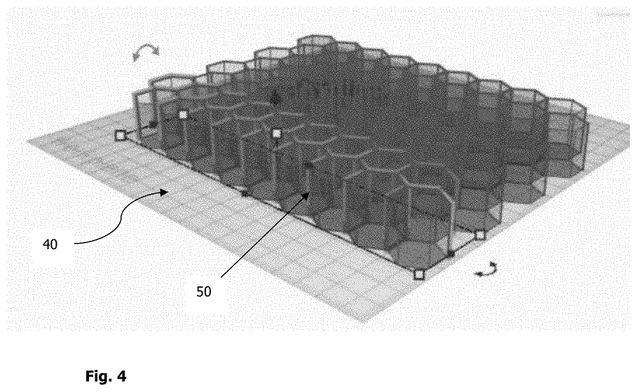

The filling elements 10 are fabricated using a die 40 and a press (not shown). The die 40 is depicted in the top view of FIG. 3, and a portion of the die 40 is schematically represented in FIG. 4. The die 40 has a honeycomb like appearance defined by a plurality of hexagonal die units 50. Each die unit 50 has six edges in the form of blades defining the perimeter of a hexagon. The die 40 is fabricated from stainless steel, tool steel or another durable metal. The die 40 is fabricated from a sheet of steel, and may be as thin as 3 to 4 mm. Alternatively, the die 40 may be fabricated from a thicker sheet, being 10-12 mm or thicker for increased rigidity.

Whilst the die 40 has been described and shown with respect to a hexagonal filling elements 10, it will be appreciated by those skilled in the art that other shaped filling elements 10 may be produced, such as (and not limited to) circles, triangles, squares, rectangles, other polyhedrons (regular or irregular), squiggles, waves, crosses and stars.

Most preferably, the filling elements 10 are fabricated having complimentary cross-sectional profiles which can be nested side by side with no spaces, meaning that the filling elements 10 can be fabricated by the die 40 with no wastage (or minimal wastage) from a block of polyurethane foam.

When a block of polyurethane memory foam (not shown) is pressed against the die with a press, the blades of each die unit 50 cut into the polyurethane foam. The foam block is pressed through the die, from a front surface, and the filling elements 10 are extruded from the rear surface of the die 40. Each filling element 10 has a cross sectional area corresponding generally with the internal perimeter shape of the corresponding die unit 50. In this manner, the filling elements 10 are fabricated efficiently, with a minimum of wasted foam. The only foam which is not converted into filling elements 10 is a small portion around the perimeter of the block of foam. As such, the fabrication process for making the filling elements 10 is very efficient and minimises wastage.

Inside the pillow 20, the filling elements 10 sit against and in abutment with the adjacent filling elements 10. Due to the hexagonal shape of the cross-sectional profile, it is possible for the filling elements 10 to nest with little to no air spaces, as the external shapes are complimentary. In practice however, air gaps will be present, due to some of the filling elements 10 being pivoted about the longitudinal axis X, and not in perfect longitudinal alignment. The presence of such air gaps serves the purpose of providing improved breathability in the pillow 20. Accordingly, the breathability properties are significantly improved over conventional solid block memory foam pillows.

Advantageously, the regular hexagonal cross sectional shape of the filling elements 10 results in there being no sharp/acute edges in the foam product, as the angle of each interface between adjacent sides of the filing element 10 is around 120 degrees. As a result, the filling elements 10 are unlikely to have prominent features which can be felt through the wall of the pillow 20, resulting in uniformity of the external surface of the pillow.

Advantageously, air spaces are present between at least some of the adjacent filling elements 10. This improves the breathability and heat dissipation properties of the pillow 20.

Although the invention has been described with reference to specific examples, it will be appreciated by those skilled in the art that the invention may be embodied in many other forms.

1. A filling element for filling fabric products comprising:
a longitudinally extending body portion fabricated from a polyurethane foam, wherein the cross-sectional shape of the filling element is generally in the form of a regular hexagon.

2. The filling element of claim 1, wherein the polyurethane foam is preferably a viscoelastic “memory” foam.

3. The filling element of claim 1, wherein the filling elements are between about 100 mm and 120 mm in length.

4. The filling element of claim 1, wherein each filling element is about 10 mm in width.

5. A pillow or cushion having a casing fabricated from a cellulose fibre fabric, wherein the pillow or cushion is filled with filling elements according to claim 1.

6. The pillow or cushion of claim 5 further comprising an opening providing access to an internal receptacle.

7. The pillow or cushion of claim 6, wherein the filling elements are arranged in the casing with a longitudinal axis of a majority of the filling elements being generally parallel, or at least extending predominantly in a similar direction.

8. The pillow or cushion of claim 7, wherein the filling elements are arranged with the longitudinal axis generally following a longitudinal axis of the casing.

9. A die for fabricating the filling elements of claim 1, wherein the die has a honeycomb like appearance defined by a plurality of hexagonal die units, each die unit having six edges in the form of blades defining the perimeter of a hexagon.
